(19) United States
(12) Patent Application Publication
(10) Pub. No.: US 2013/0059129 A1
(43) Pub. Date: Mar. 7, 2013

(54) MOLDED SKIN AND METHOD OF PRODUCING A MOLDED SKIN

(71) Applicant: Denis Perinet, Strasbourg (FR)

(72) Inventor: Denis Perinet, Strasbourg (FR)

(73) Assignee: Faurecia Innenraum Systeme GmbH, Hagenbach (DE)

(21) Appl. No.: 13/520,119

(22) PCT Filed: Dec. 30, 2010
(86) PCT No.: PCT/EP10/08004

§ 371 Date: Nov. 19, 2012

(30) Foreign Application Priority Data
Dec. 30, 2009 (DE) 10 2009 060 943.1

(51) Int. Cl. B32B 27/30; B28B 1/20; B32B 33/00; B29C 41/08

(52) U.S. Cl. 428/195.1; 264/309; 264/643

(57) ABSTRACT

A molded skin includes a plastisol layer that is formed of a first plastisol having a first color. A plurality of plastisol splashes are introduced into the surface of the plastisol layer. The plurality of plastisol splashes are formed of a second plastisol having a second color different from the first color and have a median diameter that is less than about 200 μm. The molded skin provides a very durable optical effect that is achieved in a simple manner.

### CROSS-REFERENCE TO RELATED APPLICATION

The present application is a national phase application of PCT application PCT/EP2010/008004 filed pursuant to 35 U.S.C. § 371, which claims priority to German Application DE 10 2009 060 943.1, filed Dec. 30, 2009. Both applications are incorporated herein by reference in their entirety.

### TECHNICAL FIELD

The invention relates to a molded skin with a first plastisol layer having a first color as well as to a method of manufacturing a molded skin. Molded skins of this category are used as surface decor in the automotive sector, for example, and are usually manufactured by rotational sintering.

### BACKGROUND

Molded skins of the prior art are either monochrome or only have larger separate part regions of different color. Complicated visual effects cannot be made possible or can only be made possible in a laborious and/or expensive manner.

It is in particular not possible according to the prior art to manufacture molded skins whose surface shows the “stone-washed effect” known per se in particular from the clothing industry.

A method of manufacturing molded skins having a spotted surface is disclosed in the document JP 02-141212 A. In the method, relatively large color spots are produced, however, so that a “stone-washed effect” is not possible by it. A diminution of the color dots to achieve the effect would not be possible with the plastics usually used since too great a mixture of the color dots with the surrounding material would occur.

### SUMMARY

Embodiments of the invention pertain to a molded skin which shows visual effects of a high quality appearance, with the visual effect being as permanent as possible, as well as to a method for manufacturing such a molded skin, with the method being able to be carried out as simply as possible and as reliably as possible.

Since the molded skin includes a plastisol layer having a first color, wherein a plurality of plastisol spots are introduced into the surface of the plastisol layer which have a second color differing from the first color, a visual effect which has a high-quality appearance is achieved in a simple manner. Since the median diameter of the applied plastisol spots is smaller than 200 μm, a “stone-washed effect” can be achieved.

Such a molded skin can be manufactured by first spraying the second pigmented plastisol having the second color onto a surface of a mold. This is done in that it is not a closed layer which is formed on the mold surface, but rather a plurality of mutually separate plastisol spots. Subsequently, the first plastisol, which has a color differing from the color of the second plastisol, is sprayed onto the mold surface. The molded skin formed in this manner is then hardened and removed from the mold.

The exact shape of the surface is predefined solely by the mold by this type of manufacture. The plastisol splashes including the second plastisol are embedded into the surface of the plastisol layer including the first plastisol. A visual effect of a high-quality appearance and simultaneously a surface not rough in an unwanted manner can thus be achieved.

A plastisol is understood as a mixture of polymers and plasticizers as well as optionally further additives. A solubility of the polymers in the plasticizers is low at room temperature, and is considerably increased at an elevated temperature, for example of more than 100° C. or more than 150° C. Dissolving at elevated temperature is irreversible such that a repeat cooling does not result in a separation of polymers and plasticizers. The dissolving of the polymers in the plasticizer is often called gelling.

The term “plastisol” covers both the still non-gelled mixture and the solid arising after the gelling.

More than 5 spots are applied in a first embodiment. In further embodiments, more than 10, 100, 1000 or 10,000 spots are applied.

In an embodiment, the first plastisol and/or the second plastisol include a material containing PVC (polyvinyl chloride). The material containing PVC can be predominantly PVC. In some embodiments, the first and second plastisols can be predominantly identical, with there only being a difference in the coloring contained and optionally in the amount of the solvent and/or plasticizer used.

In an embodiment, the molded skin is made in a single layer. A particularly simple manufacture is hereby possible. In such embodiments, the plastisol layer can have a thickness, for example between 0.5 mm and 2 mm. In some embodiments, the plastisol layer can have a thickness between 1 mm and 1.5 mm.

In alternative embodiments, the plastisol layer only forms a top layer that is thin in comparison with a total thickness of the molded skin. The molded skin then includes a further layer which is applied to the side of the plastisol layer remote from the plastisol spots. In such embodiments, the thickness of the plastisol layer can be between 50 and 250 μm, for example, whereas the thickness of the further layer is selected, for example, so that a total thickness of the molded skin amounts to between 0.5 mm and 2 mm or between 1 mm and 1.5 mm.

Such a further layer can, for example, be formed as a slush layer and can be produced by a rotational sintering method step after application of the plastisol layer. The formation of the molded skin with a further layer is advantageous as because both the plastisol spots and the plastisol layer include plastisol, there is an improved adhesion between the spots and the molded skin, with the large part of the molded skin simultaneously being able to be formed from more favorable PVC powder.

In a further embodiment, the median diameter of the applied plastisol spots is less than 200 μm. In some embodiments, the median diameter is less than 100 μm. In some embodiments, the median diameter is less than 80 μm. A “stone-washed effect” is produced by such small plastisol spots which cannot be resolved individually from a usual observation distance with relaxed viewing. Such an effect has previously only been known from the textile industry, with the effect there not being achieved by color splashes of small diameter applied to a monochrome surface, but rather by direct and irregular wear of the textile. This manner of producing a “stone-washed effect” is not suitable for the automotive sector since it results in the desired effect, but also results in a reduced service life. Such a service life is not acceptable in particular in the automotive sector in which a replacement of parts is associated with a substantial effort. It was hereby not possible for the skilled person up to now to provide a “stone-washed effect” on molded skins for use in the automotive sector despite the existing demand.

In further embodiments, a viscosity of the first plastisol and/or the second plastisol before hardening amounts to at least 1 or at least 5 Pa·s at a shear rate of 0.1/s and a temperature of 23° C. In some embodiments, the viscosity is at least 10, 30 or 40 Pa·s at a shear rate of 0.1/s and a temperature of 23° C. Such a high viscosity at low shear rates is advantageous with respect to the first plastisol since it prevents the plastisol from running down the mold wall during application and thus an uneven layer thickness of the plastisol layer is hereby prevented. The same advantage results with respect to the second plastisol, with the high viscosity additionally preventing the second plastisol from excessive mixing with the first plastisol on the application thereof

In a further embodiment, a viscosity of the first and/or second plastisols before the hardening amounts to at most 20 or at most 10 Pa·s at a temperature of 23° C. and a shear rate of 100/s. In some embodiments, the viscosity is at most 5, 2 or 1 Pa·s, at a temperature of 23° C. and a shear rate of 100/s. A good spray-on capability of the corresponding plastisol is achieved by such a low viscosity at high shear rates, with this being particularly advantageous for the second plastisol since an atomization into very small droplets for forming plastisol spots of small diameter, as described above, can only be achieved with difficulty at a higher viscosity.

In additional embodiments, the viscosity is high at low shear rates, as described above, whereas the viscosity is low at high shear rates, as described above. The advantages of both viscosity ranges are thus achieved since a high shear rate is present during spraying which results in a low viscosity, whereas a much higher viscosity is present after the spraying due to the low shear rate. Depending on the embodiment, the viscosity at the shear rate of 100/s can be at least twice as high, three times as high, five times as high, ten times as high or twenty times as high as at a shear rate of 0.1/s.

In a further advantageous embodiment of the method, a spacing of a first nozzle from the mold surface for spraying the first plastisol is selected to be smaller than a spacing of a second nozzle from the mold surface for spraying the second plastisol. A sufficiently wide distribution in order to reliably to avoid a formation of a closed layer is made possible by the large spacing when spraying the second plastisol. When spraying the first plastisol, in contrast, the formation of a closed layer is ensured by the comparatively small spacing.

In a further embodiment of the method, spraying of the first plastisol and/or second plastisol takes place automatically. For this purpose, positions of a spray apparatus used for the spraying can be varied automatically. In addition, a pressure in the spray apparatus can be varied automatically. If the spray apparatus is formed as a nozzle or the like, an opening diameter can additionally be automatically variable.

### BRIEF DESCRIPTION OF THE FIGURES

Advantageous embodiments of the invention will be explained in more detail with reference to the following Figures:

FIG. 1 is a detail of a section through a molded skin in accordance with a first embodiment of the invention;

FIG. 2 is a plan view of the molded skin of FIG. 1;

FIG. 3 is a detail of a section through a molded skin in accordance with a second embodiment of the invention;

FIG. 4 illustrates a first method step in accordance with the embodiments shown in FIGS. 1 to 3;

FIG. 5 illustrates a second method step in accordance with the embodiments shown in FIGS. 1 to 3;

FIG. 6 illustrates a third method step in accordance with the embodiment shown in FIG. 3; and

FIG. 7 provides viscosity curves for different plastisol compositions in dependence on the shear rate in each case; and

FIG. 8 provides a further viscosity curve as well as shear stress in dependence on the shear rate.

### DETAILED DESCRIPTION

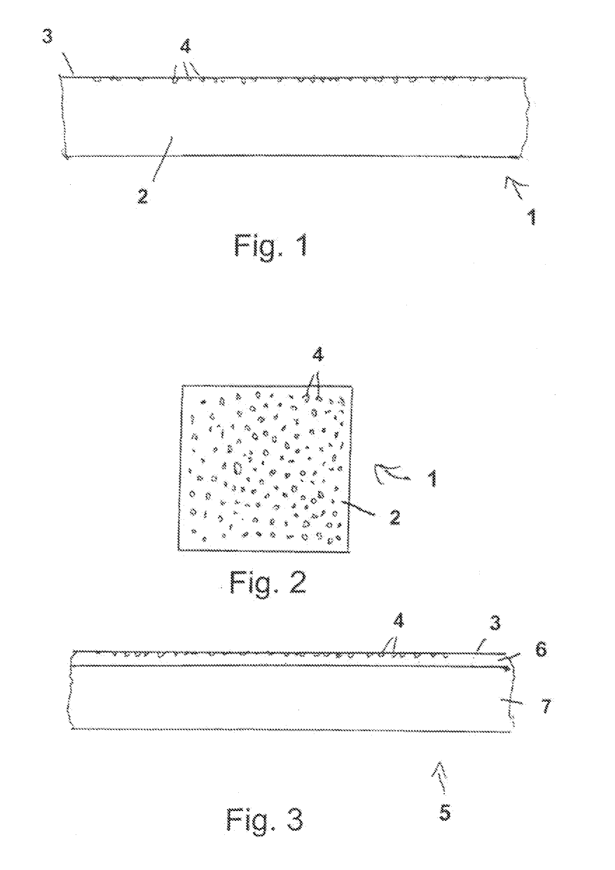

FIG. 1 shows an enlarged detail of a molded skin 1 in accordance with a first embodiment of the invention. The molded skin has a single layer structure and includes a layer 2 with a surface 3. The layer 2 in the present embodiment is approximately 1.2 mm thick and includes a plastisol of a first color. In the hardened state, the plastisol has a degree of hardness of 71 Shore A. A plurality of plastisol splashes 4 have been introduced into the surface 3 of the layer 2. In a plan view of the molded skin 1, the layer 2 can partly be seen and partly the splashes 4. The plastisol splashes 4 have a different color than the plastisol layer 2. A visual effect of a high-quality appearance therefore arises.

The surface of the molded skin 1 is smooth, with a leather-like, grainy surface structure also being possible in alternative embodiments. A surface structure is, however, independent of the applied plastisol splashes 4, i.e. the plastisol splashes are molded into the surface and do not form elevated portions set off from the remaining surface of the layer 2. Neither an appearance of the surface structure nor a surface feel thereof are thus negatively influenced by the plastisol splashes. In addition, a wear resistance of the plastisol splashes 4 is increased in that they are introduced into the surface 3 of the layer 2.

In the embodiment shown in FIGS. 1 and 2, a median diameter of the plastisol spots is 50 μm. The plastisol spots are hereby no longer separately resolved with relaxed vision and customary observation distances and conditions. Instead, a stone-washed effect is perceived as a total effect.

A second embodiment of a molded skin 5 in accordance with the invention is shown in FIG. 3. This molded skin differs from the molded skin from FIGS. 1 and 2 in that it has a two-layer structure. The plastisol splashes 4 are, as in the first embodiment, introduced into the surface 3 of a plastisol layer 6. The plastisol layer 6, however, only has a thickness of approximately 200 μm. A further layer 7 is applied to the rear side of the plastisol layer. The thickness of the further layer 7 is selected so that the molded skin has a total thickness of approximately 1.2 mm. In the present example, the further layer 1 is 1 mm thick.

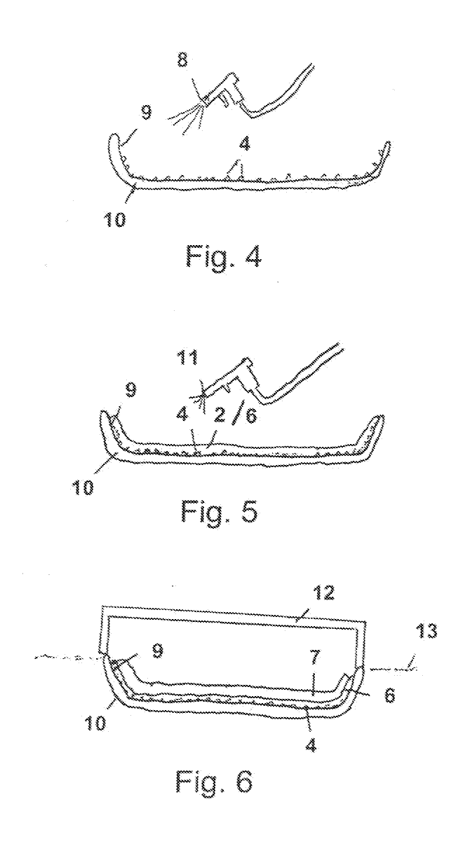

FIG. 4 shows the first step of a method in accordance with the invention. The second plastisol is sprayed onto a surface 9 of a mold 10 using a spray apparatus formed as a nozzle 8 such that no contiguous layer is formed, but rather a plurality of plastisol splashes. A spacing of the spray apparatus from the mold surface 9 can be, for example, between 70 and 100 cm. A position of the spray apparatus can advantageously be set and varied automatically so that reproducibility is present. It can moreover be advantageous to spray on the second plastisol from a plurality of different directions since hereby a more uniform distribution of the plastisol splashes can be achieved. The mold 10 can be formed, for example, as an electroplated nickel shell.

The second plastisol is formed as plastisol containing PVC. The plastisol predominantly includes a dispersion of PVC spheres of around 30 μm in size. The plastisol additionally contains plasticizers, 5-15% by volume pigments, process stabilizers, means to increase stability in age, solvents (such as 12-18% by volume) and rheology enhancers. Further additives can also be of advantage depending on the desired design of the molded skin.

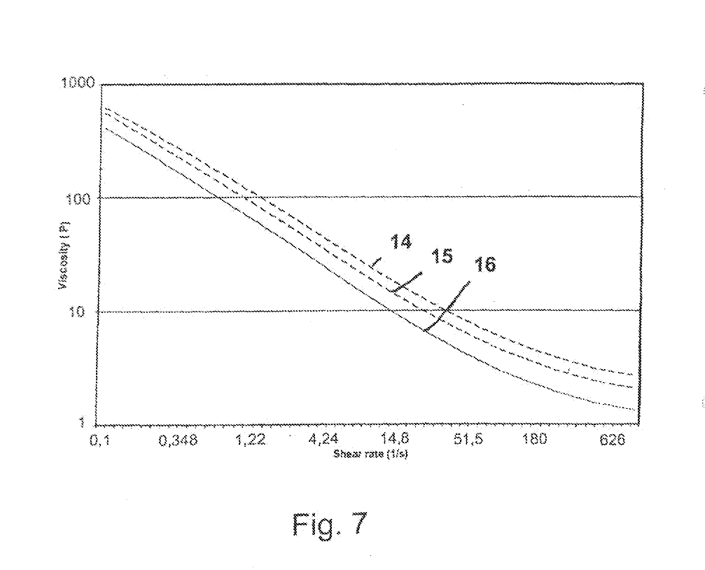

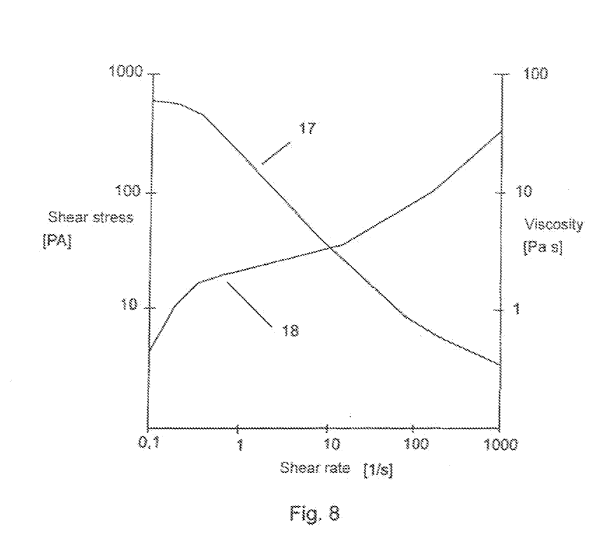

The second plastisol has a viscosity of only 0.7 Pa·s at higher shear rates of 100/s. An easy sprayability is hereby present. At the same time, the second plastisol has a viscosity of around 60 Pascal seconds at low shear rates of around 0.1/s. Since the second plastisol is highly viscous at low shear rates, running of the plastisol is avoided. The advantages of a high viscosity at low shear rates and of the low viscosity a high shear rates are combined by the shear dilution which occurs. Viscosity curves 14, 15, 16 in dependence on the shear rate are shown as FIG. 7 for three different solvent contents (12% for curve 14, 15% for curve 15, 18% for curve 16) for further illustration. The shear rates given each relate to the plastisol still not hardened at a temperature of 23° C. The viscosity is likewise shown schematically as a graph 17 in FIG. 8 in dependence on the shear rate for an example plastisol. In FIG. 8, the curve 18 of the shear stress is moreover shown in dependence on the shear rate. Suitable plastisols with comparable properties as shown in FIG. 8 can be obtained, for example, from the companies of Arkema or Anton Paar GmbH.

As is shown in FIG. 5, a first plastisol is sprayed on after application of the plastisol splashes so that a layer 2 or 6 respectively is formed. A second nozzle 11 can be used for spraying on. A pressure of the plastisol in the nozzle and/or a spray distance and/or a displacement speed of the nozzle over the surface 9 of the mold 10 is selected such that a uniform layer having the desired layer thickness is produced. A spray distance can amount, for example, to between 30 and 70 cm and can thus be smaller than the spray distance on the application of the second plastisol. The composition of the first plastisol can be almost identical to that of the second plastisol, with only a solvent content and the contained pigments being different. A strong bonding of the plastisol splashes to the layer 2 or 6 respectively is possible by the thus similar composition of both plastisols.

Depending on the embodiment, a plurality of layers of different plastisols can also be sprayed on, with the plastisols being able to differ, for example, by a different degree of hardness.

The first plastisol used is in this embodiment essentially identical to the second plastisol and only differs by a color of the pigments and by a solvent content. A particularly strong connection between the plastisol splashes 4 and the layer 2, 5 is hereby possible. Due to the almost identical composition, the first plastisol also has a viscosity as described above. Due to the high viscosity of both plastisols at low shear rates, a mixing of the two plastisols on the spraying on of the first plastisol is precluded.

The mold is heated after the spraying to harden the plastisols. In the first embodiment, the mold is heated to 285° C., for example. In accordance with the embodiment shown in FIGS. 1 and 2, the molded skin is now finished and can be removed from the mold.

In the case of the embodiment shown in FIG. 3, the layer 6 formed up to now is back-slushed to form the further layer 7, as shown in FIG. 6. For this purpose, a powder box 12 having a polymer powder formed as a PVC powder is placed onto the preferably still hot mold. Subsequently, the mold 10 together with the powder box 12 is rotated about an axis 13 and may simultaneously be further heated. The powder adheres to the layer 6 arranged in the hot mold 10 and forms the further layer 7 which is gelled by further heating. The molded skin 1 formed in this manner can be removed from the mold 10.

A further aspect of the invention relates to a molded skin (1; 5) including a plastisol layer (2, 6) including a first plastisol having a first color, with a plurality of plastisol splashes (4) being introduced into a surface (3) of the plastisol layer which includes a second plastisol having a second color different from the first color. This can be considered advantageous independently of the size of the plastisol splashes per se and in combination with any other features named in the description or in the claims.

The same applies to a method of manufacturing a molded skin (1; 5) including the steps:

spraying on a plastisol layer (2; 6) of a first plastisol onto a surface (9) of a mold (10);

preceding spraying on of a second plastisol having a second color onto a mold (10) such that a plurality of mutually separate plastisol spots (4) are formed on the surface (9) of the mold (10), with the second plastisol having a second color different from the first color;

hardening and removing the molded skin (1; 5).

1-12. (canceled)

13. A molded skin comprising:
a plastisol layer formed of a first plastisol having a first color, the plastisol layer including a surface; and
a plurality of plastisol splashes introduced into the surface of the plastisol layer, the plurality of plastisol splashes formed of a second plastisol having a second color different from the first color;
wherein the plastisol splashes have a median diameter that is less than about 200 μm.

14. The molded skin of claim 13, wherein the plastisol layer comprises a material containing polyvinyl chloride.

15. The molded skin of claim 13, wherein the molded skin is formed in one layer.

16. The molded skin of claim 13, further comprising a further layer, wherein the plastisol layer is arranged on the further layer.

17. The molded skin of claim 16, wherein the further layer is formed as a slush layer.

18. The molded skin of claim 13, wherein the median diameter of the plastisol splashes is less than about 100 μm.

19. The molded skin of claim 13, wherein the median diameter of the plastisol splashes is less than about 80 μm.

20. The molded skin of claim 13, wherein the molded skin has a total thickness in a range of about 0.2 to about 2 mm.

21. The molded skin of claim 20, wherein the plastisol layer has a thickness in a range of about 50 μm to about 250 μm.

22. A method of manufacturing a molded skin, the method comprising:
spraying a second plastisol having a second color onto a surface of a mold such that a plurality of mutually separate plastisol splotches are formed on the surface of the mold, the plastisol splotches having a median diameter that is less than about 200 μm;
subsequently spraying a first plastisol onto the surface of the mold to form a plastisol layer, the first plastisol having a first color different from the second color;
hardening the molded skin; and
removing the hardened molded skin.

23. The method of claim 22, further comprising a subsequent step of forming a further layer via rotational sintering.

24. The method of claim 22, wherein the first plastisol and/or the second plastisol has a viscosity, before hardening, of at least 1 Pa·s at a temperature of 23° C. and a shear rate of 0.1/s.

25. The method of claim 22, wherein the first plastisol and/or the second plastisol has a viscosity, before hardening, of at least 5 Pa·s at a temperature of 23° C. and a shear rate of 0.1/s.

26. The method of claim 22, wherein the first plastisol and/or the second plastisol has a viscosity, before hardening, of at least 10 Pa·s at a temperature of 23° C. and a shear rate of 0.1/s.

27. The method of claim 22, wherein the first plastisol and/or the second plastisol has a viscosity, before hardening, of at most 20 Pa·s at a temperature of 23° C. and a shear rate of 100/s.

28. The method of claim 22, wherein the first plastisol and/or the second plastisol has a viscosity, before hardening, of at most 10 Pa·s at a temperature of 23° C. and a shear rate of 100/s.

29. The method of claim 22, wherein the first plastisol and/or the second plastisol has a viscosity, before hardening, of at most 5 Pa·s at a temperature of 23° C. and a shear rate of 100/s.

30. The method of claim 22, wherein spraying a second plastisol with a spray apparatus comprises spraying at a distance that is greater than a distance of a further spray apparatus used for spraying the first plastisol.

31. The method of claim 22, wherein spraying the first plastisol comprises spraying in an automated manner.

32. The method of claim 22, wherein spraying the second plastisol comprises spraying in an automated manner.
